(19) United States
(12) Patent Application Publication
(10) Pub. No.: US 2022/0144607 A1
(43) Pub. Date: May 12, 2022

(54) CRANK MECHANISMS FOR TRAILER JACKS

(71) Applicant: HORIZON GLOBAL AMERICAS INC., Plymouth, MI (US)

(72) Inventors: Eric Stoddart, Plymouth, MI (US); Brent Lyons, Plymouth, MI (US); Gregoire Mercier, Plymouth, MI (US)

(21) Appl. No.: 17/521,126

(22) Filed: Nov. 8, 2021

Related U.S. Application Data
(60) Provisional application No. 63/110,618, filed on Nov. 6, 2020.

(51) Int. Cl. B66F 3/08

(52) U.S. Cl. CPC B66F 3/08

(57) ABSTRACT

A crank mechanism incorporates a ratchet driver post coupled with a conventional, manually operated crank handle. The post is configured, possibly relying upon biasing members, pins, or sleeves, to ensure the ratchet driver may be operated without unwanted rotation of the handle. A number of iterations provide for multiple positions of the handle itself so as to speed up the early stages of jack actuation and then allow for repositioning in the later stages to maximize the user's leverage. Further still, a disengagement driver gear can be employed, and the invention may incorporate any combination of these features to improve operation and extension/retraction of the jack.

### CROSS REFERENCE TO RELATED APPLICATIONS

This application claims priority to U.S. provisional patent application 63/110,618 filed on Nov. 6, 2020, which is incorporated by reference in its entirety herein.

### FIELD OF THE INVENTION

The present invention is generally related to crank mechanisms for trailer jacks and, more particularly, to a series of dual use designs featuring a driver engagement post coupled with an adaptable crank handle.

### BACKGROUND

Jacks are often used in association with towed vehicles, such as trailers. Jacks may be used for many different functions including, without limitation, holding the towed vehicles in place when not connected to towing vehicles, appropriately positioning towed vehicles to operatively connect with towing vehicles, storing towed vehicles or any such similar situations. Additionally, jacks may be used with both loaded and unload towed vehicles. This may apply significantly varying loads on the jacks causing them to operate under significantly varying conditions. Jacks, therefore, must function properly and reliably under these varying conditions.

U.S. Pat. No. 6,302,381 provides an example of a swivel jack assembly, including details on the manner in which attachment brackets for can be secured to the jack itself. U.S. Pat. No. 6,874,764 describes a mechanical screw jack. U.S. Pat. No. 9,809,072 discloses arrangements for drive gears and other functional components commonly found in jack assemblies. All of these patents are incorporated by reference herein. It will be understood that jack assemblies designed for use with towing and trailers, where portability and use of use are important considerations, tend to differ from hydraulic, scissors, or other service-type jacks commonly relied upon for maintenance purposes.

The method of deployment of such jacks often influences the end user's experience. To the extent they may be slow or difficult to deploy, users can become frustrated. Therefore, the time of actuation to deploy the jack (i.e., extend the length of the body in order to elevate a load attached to it) is an important consideration. For example, extension times of 30-90 seconds are common.

Jacks are usually actuated by a rotationally-driven crank mechanism so as to rely on hand-operated handles, ratchet drivers, or automated, electrical systems. However, existing jack designs tend to rely primarily on only one driver system (e.g., a handle-turned crank or a ratchet post). To the extent multiple drivers are accommodated, these systems typically allow the handle-turned crank to move in response to the ratchet/automated driver, thereby causing rapid and seemingly uncontrolled spinning of the handle when the alternative driver (e.g., the electrical system) is engaged. While temporarily detachable handles can help to avoid this seemingly dangerous condition, such handles create can be forgotten or easily misplaced.

U.S. Pat. No. 10,343,654 discloses a tongue jack for attachment to a trailer. The jack include a crank handle and a screw whose drive head is contained within an axially sliding collar. When the crank handle is pivoted to its operational position, biasing force holding the collar is overcome and the drive head is concealed so that internal splines on the collar and the drive head engage so as to allow rotation of the crank handle to drive the screw. Conversely, when the crank is pivoted 180° (or more), a cam on the crank urges the collar downward to expose the screw head so that an external driver (e.g., a motor) can be used. One drawback of this configuration is that the crank must be completely pivoted, but the screw head can be exposed and operable while the splines are still engaged, which causes the external driver to engage the drive nut and spin the crank handle (unless the handle is completely nested in the disengaged position).

Therefore, there is a need for a crank mechanism that is quickly deployed and capable of being driven by ratchet (automated or manual) or hand crank without causing the handle to spin when the ratchet driver is engaged. Further still, a design that can be incorporated in side- or top-winding jacks and/or retrofitted to existing components and technologies (e.g., slip or other clutches, varying socket types, etc.) would be welcomed. Lastly, a design is needed to avoid any ambiguity in terms of when the drive head may be engaged or disconnected from the crank handle.

### SUMMARY

A number of varying jack features and designs are described to address the aforementioned shortcomings of the prior art, with all of these inventive designs relying upon a conventional ratchet driver post coupled with a selectively-engaged, manually-operated crank handle. The post may be fitted with biasing members, pins, or sleeves, to alternate between socket wrench or automated drivers and by manual operation of the crank handle. Additionally, iterations of the crank handle itself may provide for multiple operating positions so as to speed up the early stages by shortening the rotational arc and then repositioning in the later stages to maximize leverage. Lastly, a disengagement driver gear can be employed that allow for handle positioning on the top or side. Specific aspects may incorporate any combination of these features to improve operation and extension/retraction of the jack.

### BRIEF DESCRIPTION OF THE DRAWINGS

Operation of the invention may be better understood by reference to the following detailed description taken in connection with the following illustrations, wherein:

FIGS. 1A through 1D show perspective views of various prior art, jack deployment systems. FIG. 1A depicts a side-winding crank that relies upon a transmission system to translate rotational movement of the crank to turn the drive screw of the jack, while FIG. 1B generally depicts a top winding crank directly turning the drive screw. FIGS. 1C (crank engaged) and 1D (crank disengaged and drive screw head exposed) illustrate the system described in U.S. Pat. No. 10,343,654 noted above, with arrow 1C indicating the pivotal range of rotation required to disengage the crank.

FIG. 2 is a three dimensional, perspective view of a screw-driven jack having a hex-head driver and a manual crank.

FIGS. 3A and 3B are opposing, complimentary three dimensional, perspective views of a first aspect of the invention having a crank sleeve and cooperating pin to allow for the selective engagement of a ratchet driver (FIG. 3A) or the manual crank (FIG. 3B).

FIGS. 4A and 4B are three dimensional, perspective views of a second aspect of the invention having a forked crank to allow for the selective engagement of the handle or ratchet driver of the manual crank (FIG. 4A) or a ratchet driver (FIG. 4B).

FIGS. 5A and 5B are three dimensional, perspective views of a third aspect of the invention employing a biasing member (FIG. 5A) and a manually-set interference fit (FIG. 5B) so that use of a ratchet driver automatically displaces and disengages the manual crank.

FIG. 6A is a side plan view and FIG. 6B a top plan view, both of fourth aspect of the invention involving a manual crank with a torque-adjustable handle and biasing member so that the use of a ratchet driver automatically displaced and disengages the manual crank. FIG. 6C is a three dimensional, perspective view of an alternative arrangement of this fourth aspect, in which the biasing member is concealed within the body (the fast handle aspect is omitted from this view).

FIG. 7A complimentary three dimensional, perspective views of the crank lever in the high speed/low torque (top) and low speed/high torque (bottom) positions and FIG. 7B an exploded side plan view of the crank and handle assembly, all of which depict a fifth aspect of the invention involving a manual crank with a torque-adjustable handle.

FIG. 8 is a schematic side view of a disengagement gear drive for use with a sidewinding jack.

FIGS. 9A (retracted) and 9B (extended) are complimentary, cross sectional side schematic views of the screw mechanism as it is contained within the lower portion of the jack body (and isolated from the upper body and crank mechanisms contemplated in FIGS. 2-8). In this manner, FIGS. 9A and 9B may combined with the various aspects of invention described and depicted herein.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggests otherwise.

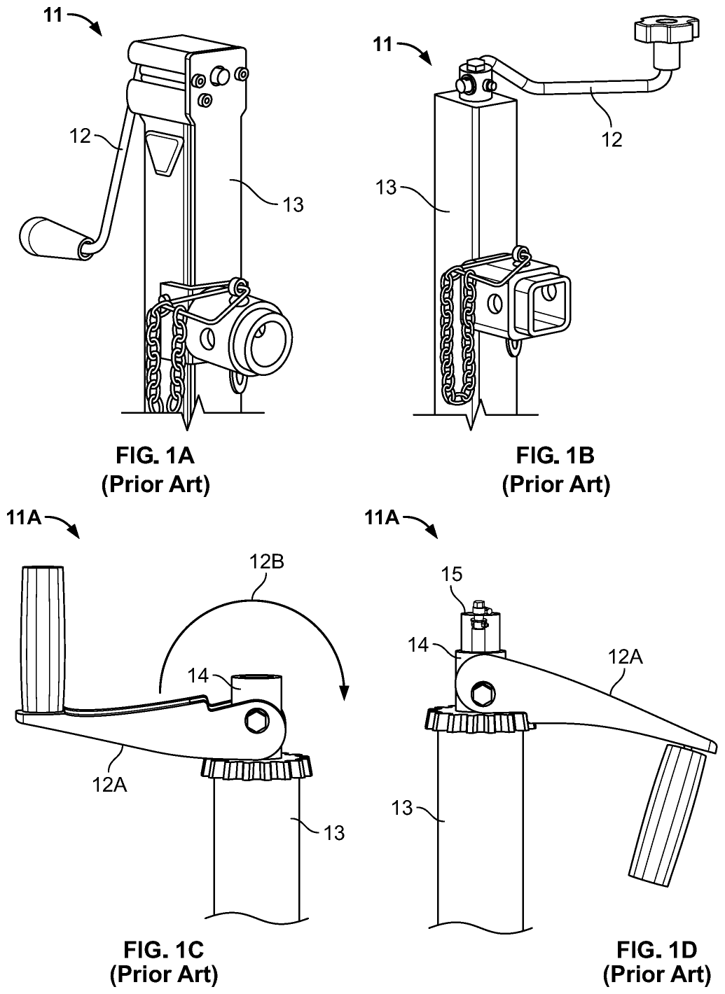

With reference to the appended drawings, conventional jacks 11 can be seen in FIGS. 1A and 1B. Generally speaking, jack 11 includes an actuation member 12. Member 12 can be rotated in a vertical (i.e., side-winding, as in FIG. 1A) or horizontal (i.e., top-winding, as in FIG. 1B) plane. The shank of member 12 engages gears and/or shafts housed within the body portion 13 which drive an axially moving screw contained within and fixed to an coaxially extending/retracting section of the body 13 (i.e., a lower half not visible in FIGS. 1A and 1B). As the handle rotates, this screw moves up or down (depending on the direction of rotation) to effect corresponding movement in the foot, lower tube or upper tube of the jack. Thus, the jack 11 can be employed to adjust the height of a trailer/towing component to facilitate coupling and detachment to towing apparatus on a vehicle. Various other details about the jack 11 and its operation can be gleaned from the patents identified above, which are incorporated by reference. Also as noted above, a fundamental shortcoming of these configurations is that the screw can only be moved by manual operation of the crank/member 12.

FIGS. 1C and 1D provide a solution to this shortcoming by providing a jack 11A with a pivotal handle 12A. In particular, handle 12A has a camming lobe at the end proximate to body 13. This camming lobe induces axial force sufficient to pull down a collar 14 that then exposes the drive head 15 of the screw. In this manner, manual and automated engagement of the jack 11A can be realized. Also, when the handle 12A is full rotated to the down position through arc 12B (shown in FIG. 1D) which necessarily entails a range of motion greater than 180° , radial teeth on the body engage the edges of handle 12A to prevent rotation of the handle 12A in the down position. However, this configuration causes the drive head 15 to become exposed before the handle 12A is locked down, so that it is possible to engage the drive head 15 without the handle 12A fully down so as to cause it to spin uncontrollably as the drive head 15 is rotated. Additionally, this arrangement requires an internal and concealed biasing member to retain the desired positioning of the collar 14 relative to the drive head 15.

Realizing the aforementioned shortcomings of these designs, the inventors conceived a series of improvements reflected in the various aspects of the disclosure described herein. Although some of these improvements are directed to discrete elements (e.g., the crank with torque adjustable handles), it will be understood that aspects of the inventions disclosed herein may include any combination or permutation of the individual improvements described below. In the same manner, while specific structures are indicated, it will be understood that this disclosure also contemplates other known means for producing the effects of these improvements.

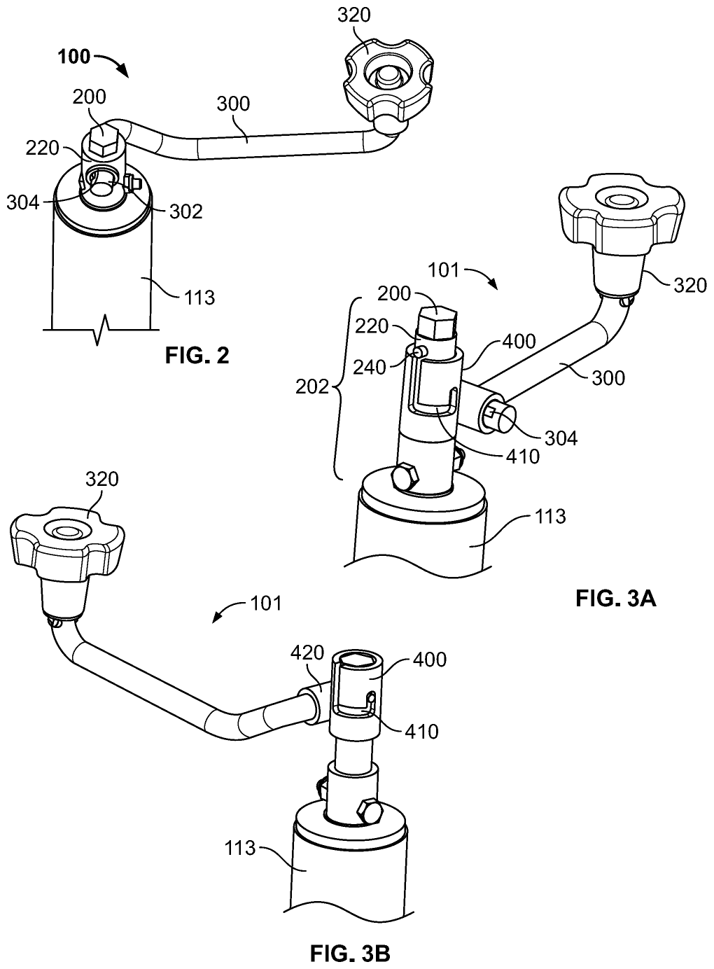

With reference to FIG. 2, the salient elements common to all aspects of the invention will be described. Jack 100 includes body 113 with a telescoping foot element or tube (not shown). A drive screw is contained within the body 113, and drive head 200 is coupled to that drive screw to control the rotation of the drive screw that changes and controls the axial extension or retraction of the telescoping foot and/or tubular member.

A manual crank member 300 may be directly or indirectly coupled to the drive head 200. As shown here, drive head 200 is engaged with a collar 220. Crank member 300 has a radial extension 302 passing through an aperture in the collar 220, and it may be held in place with a holding element 304 such as a pin, spring pin, fastener or other similar structure. Notably, the drive head 200 and collar 220 can be formed integrally or provided as separate elements, with cooperating splines, one or more pins (including the extension 302), or other engagement features machined, forged, or coupled thereto, with these features ensuring rotation of the collar 220 also rotates the head 200 under selected conditions (e.g., when the drive head 200 and collar 220 are urged into contact). In turn, the head 200 is either integrally formed with (machined, forged, etc.) or coupled to the drive screw (welded, interference fit, etc.). On its top, exposed end, the drive head 200 is shaped to cooperate with an external driver, such as a hexagonal or specially shaped socket/ratchet, a motorized driver, or other common means (it also being understood that a motorized driver or other common means can also employ hex-head or other specially shaped engagement means). One particular embodiment, is a battery operated drill or driver that includes a corresponding socket that operatively engages with the drive head 200. This may allow anyone with a battery (or electric) drill, driver or similar device to lower and raise the jack by utilizing a socket that engages the drive head 200.

FIGS. 3A and 3B show a first aspect of the system of the present disclosure. Jack 101 includes body 113, drive head 200, and crank 300. Here, a slidable engagement sleeve 400 is fit coaxially over the drive apparatus 202 (i.e., either the drive head 200 and/or the collar 220). The sleeve 400 includes one or more slotted apertures 410. Crank 300 is fixed or coupled to the sleeve 400 so that the crank 300 and sleeve 400 move in concert when the handle 320 is rotated about the axis of the drive apparatus 202. Handle 320 may be coupled to the shank of the crank 300 in a fixed or rotatable manner (or as is further described below).

The diameter of slot 410 cooperates with a pin or protrusion 240 formed on or provided to the drive apparatus 202 between the drive head 200 and collar 220 (if present). When the aligned properly, protrusion 240 is received in the slot 410, when the sleeve 400 is slid axially toward the driver head 200. The slot 410 may be formed with at least one curve or bend (as shown in FIGS. 3A and 3B, a J-shape may be utilized) so that subsequent rotation ensures the protrusion 240 is captured and, thereafter moves in concert with the rotation of the sleeve 400. Notably, a J-shape for slot 410 is useful because gravity will insure that the sleeve 400 is naturally inclined to disengage (FIG. 3A) or remain engaged (FIG. 3B) depending upon the alignment of the pin 410 relative to the slot 410. A biasing member (not shown) may be disposed beneath the sleeve 400 to facilitate these engaged or disengaged positions. Notably, when the sleeve 400 is disengaged, the drive head 200 is exposed so that an automated driver, such as a battery operated or electric drill (i.e., not the crank 300) can be used. Because the sleeve 400 rotates freely about the drive apparatus 202 and the pin 410 has sufficient axial clearance away from the sleeve 400 in the disengaged position, the crank 300 will not spin when an automated driver engages the head 200 (note that a pivoting and/or selectively attachable handle can be fixed to the body 113 to serve as a further safeguard against unwanted spinning).

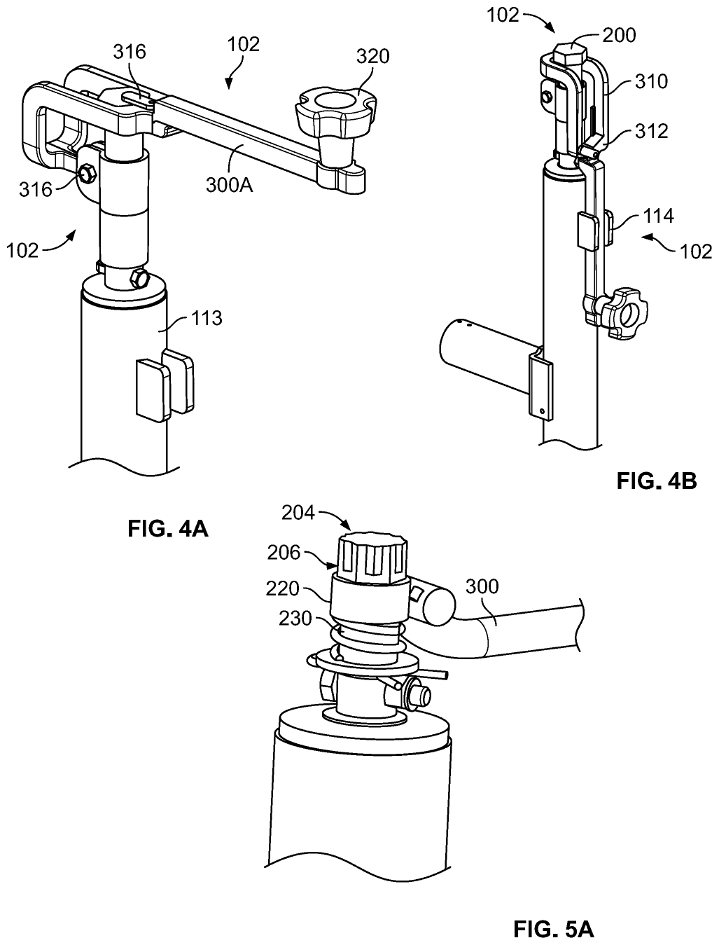

Turning to FIGS. 4A and 4B, another aspect of the system of the present discosure is shown. Here, jack 102 includes a pivotal crank 300A attached to the drive head 200 or the drive apparatus 202 A pivot point 316 is included in the attachment of the crank 300A to the drive apparatus 202 so that the crank 300A can pivot 90° between an engaged position (FIG. 4A) and disengaged position (FIG. 4B). As above, handle 320 is fixed to crank 300A to allow for gripping and easier rotation of the crank 300A, while rest 114 receives the crank 300A and holds it in a “locked out” or stowed/disengaged position.

Crank 300A is formed with a fork-like section attached to pivot point 316. In one aspect, transverse member 312 divides the main body of crank 300A into two separate fingers 310. Fingers 310 are provided with a J-shape so as to attach to pivot point 316. The fingers 310 are offset by a gap that cooperates with and conforms to the shape of the drive head 200. Pivot point 316 may be formed integrally with or coupled to the collar so that the drive head 200 rotates freely relative to the collar/pivot point 316.

Thus, when crank 300A is disposed in the engaged position (FIG. 4A), the crank 300A may be used to rotate the drive head 200. Conversely, when disengaged (FIG. 4B), crank 300A remains stationary while the drive head 200 may be engaged and driven by automated means, such as the battery operated drill or driver. Owing to the operation of gravity and the limited range of pivot for the crank 300A, this configuration minimizes and avoids any “intermediate” positions where the crank remains engaged but the drive head 200 is exposed.

Additionally or alternatively, the cradle or seat formed by the intersection of members 310, 312 can be sized so as to ensure it engages and serves as a stopper on the side facing of the drive head 200. In some aspects, this seat might include a stopper 316 such as a wall section, moveable lever, or other surface that further nests around the head 200 (i.e., above and/or below planar surface of the extension portion 641. In other aspects, the shank of the crank 300A (between member 312 and handle 320) could be angled or shaped to ensure that the entirety of the crank 300A conforms to the outer contours of the jack body 113.

While FIG. 4A shows a top winding jack, the limited, 90° range of motion makes this configuration adaptable to side winding jacks. Here, the engaged position would have the shank of crank 300A rotating in a vertical plane, while its rest 114 and locked out positions may be disposed on the top, horizontal facing of the body 113.

Handles 300 and 300A may remain permanently affixed to the jack 100, 101, 102 while simultaneously allowing for quick and easy use of the manual crank or automated means to engage drive head 200. Because some iterations have the handle fixed to the jack body, the handle is further secured and locked out from spinning as a result of any friction between the drive head and interfacing but immobile components to which the handle is affixed (e.g., in FIG. 4B, rest 114 cradles and secures the shank of handle 300A, thereby keeping it locked out).

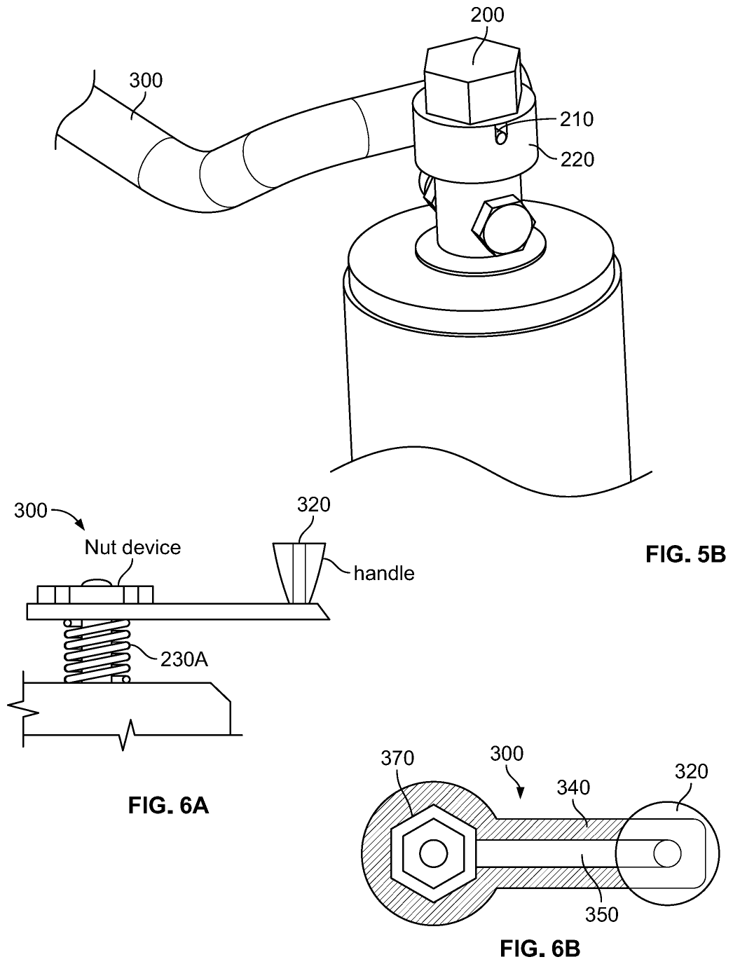

FIGS. 5A and 5B display aspects of the system of the present disclosure where a modified driver (e.g., a specialized socket) can be employed. In FIG. 5A, the top portion 204 of drive head 200 presents with a different geometry in comparison to its sidewalls 206. For example, a hexagonal sidewall arrangement in portion 206 can include additional, identically positioned indents or formations on each wall, thereby making the top portion engageable by a different shaped tool (e.g., twelve-sided). In this manner, the driver 270 can be configured for conventional consumer tools (e.g., a socket wrench) in addition to specialized drivers, such as automated electric drivers, modified drills, and other rotational implements provides with a cooperating bit configured to fit with formations

As seen in FIG. 5B, a torque pin 210 may be provided within the collar 220 (or sleeve 400) or elsewhere along the shaft or interface of the drive head 200. In this configuration, when the tool for rotating the driver directly or indirectly engages the pin 210 and forces it into (e.g., through application of axial force urging the spring-loaded pin with a rounded head) a retracted position within collar 200. Because, the crank 300 is coupled to the collar, retraction of pin 210 disengages the collar 220 (or sleeve) from the rotational movement of the drive head 200 so as to prevent or lock out the crank 300 from spinning when an automated driver engages head 200. Upon release of the axial force, pin 210 would extend and urge the crank 300 back into engagement.

In some aspects, a biasing member 230 (such as a torsion or coil spring) can be employed to urge the necessary components into alignment. As shown in FIG. 5A, spring 230 may be retained by a washer that abuts a through pin on its lower end and nested within the collar on its upper end. This arrangement urges the collar 220 into engagement with at least the lower portion 206. Because crank 300 is coupled to the collar 220 and the inner facings of collar (not visible) have a cooperating configuration to the lower portion 206, this enables manual actuation of the drive head 200. This approach can be applied to the other configurations disclosed herein, including but not limited to those in FIGS. 2, 3A, 3B, and 5B.

In all aspects, drive head 200 may be formed as a male hex bolt, although other configurations are possible (e.g., such as those below and/or by way of substituting other shapes or engagement features). Notably, drive head 200 should be accessible from the top (or, in the case of wind-winding, from the side) so as to allow sufficient clearance for a socket wrench or other driving apparatus to be affixed to and rotated about head 200.

In any of the aforementioned arrangements, drive head 200 directly or indirectly connects to components that can extend or retract the jack. Conventional components could include a slip clutch and/or gears to minimize the rotary force required to drive (i.e., move) the jack. Also, drive head 200 may be coaxially received within an upper aperture of the shaft of the drive screw (concealed in the body 113). The interface between the drive head and screw may have cooperating shapes, welded, and/or be coupled by other known means contemplated herein.

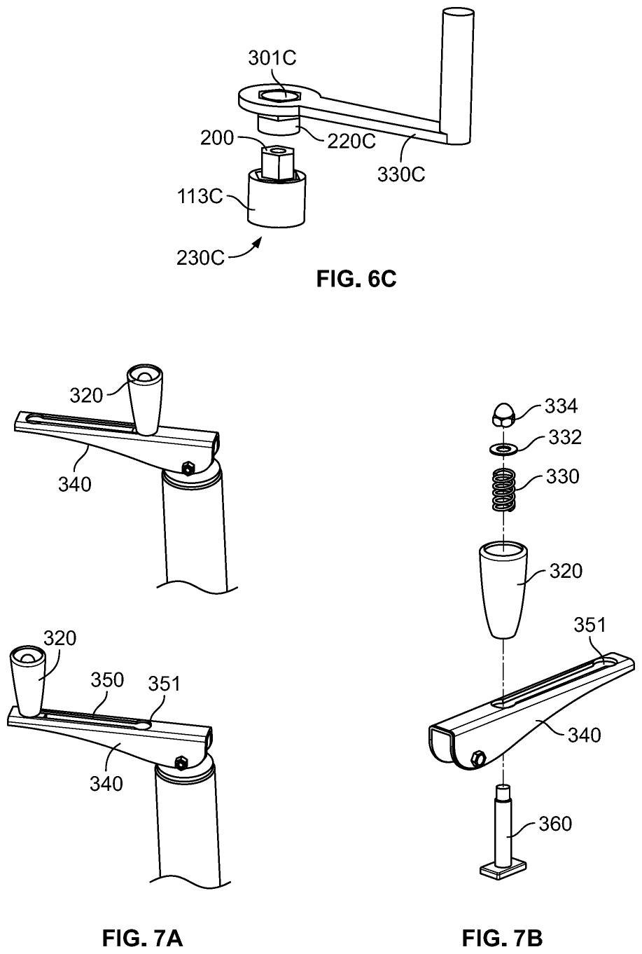

As a further improvement, a variety of “fast handles” employ a repositionable grip as shown in FIGS. 6A through 7B. Here, crank 300 includes a special shank 340 having a slot 350 oriented substantially along a radius relative to the circular motion of the handle itself In a first aspect, grip 320 is repositionable by way of a bolt, spring, washer, and nut combination. By pulling upward or outward on the grip 320, the user can slide the grip along the length of slot 350. Additionally or alternatively, notches 351 may be provided as preset positions so that the attachment bolt 360 connecting the grip 320 to the crank 300 rests in the notch 351 as the crank 300 is rotated.

In FIG. 6A, crank 300A is shown in the fast crank, low torque position, while crank 300B illustrates the slow crank, high torque position.

As best illustrated in FIG. 6B, a cooperating aperture 370 is provided in the crank 300 where it interfaces with the drive head 200 (i.e., opposite the grip 320). Specifically, aperture 370 is configured to slide over and engage the driver 270, with a biasing member 230A urging the aperture 370 into a desired engaged or disengaged position. Lubricant, rollers, and/or a low-friction, free-floating washer may be disposed on the top facing of the crank 300 proximate to the aperture 370 so that, when an automated driver is pressed down onto the drive head 200, the driver can rotate the head 200 without inducing rotation of the crank 300. To that end, cooperating engagement features can be provided on the underside of the crank 300 and a top facing of the jack body 113 to further guard against such rotation.

The ability to move the grip 320 throughout the slot 350 allows the user to adjust the relative range of motion that must be used (i.e., the circumference of the circle for one rotary actuation of the crank 300). Thus, a shorter position (i.e., where grip 320 is positioned relatively closer to its attachment point to the drive head 200) allows for faster rotation, while a more distant positioning affords the user to exert greater leverage, which could be particularly helpful under heavier loads.

In either instance, a fast handle could be incorporated with any of the aforementioned designs. Thus, the crank 300 or 300A could be outfitted with a fast handle to provide further convenience and ease of use.

FIG. 6C omits the “fast handle” aspect and, instead, provides an alternative arrangement for the spring 230A for handle 300 shown in FIG. 6A. Here, a sleeve 220C is welded to the handle 300C. A hexagonal or other appropriately shaped through-hole 301C is formed in sleeve 220C so as to cooperate with the drive head 200. Handle 300C is coupled or permanently affixed to the top of body 113C, so as to allow it to slide axially around the drive head 200.

A compression spring is concealed within body 113C. This spring rests upon a flange, divider, or extension of the bottom coaxial member (not shown) in body 113C, whereas the top member is visible in FIG. 6C. This configuration urges the top member, including handle 300C upward so that the aperture 301C engages and drives the head 200. However, when an external member is pressed axially down onto the head 200, the handle 300C and, more specifically, the aperture 301C and sleeve 220C are disengaged from the head 200 (similar to the principle behind FIG. 6A). Interlocking, axially-aligned features on the top and bottom members of body 113C can be employed to ensure they do not rotate relative to one another. Thus, the temporary, downward displacement of the handle 300C allows for external engagement of the drive head 200 while simultaneously ensure that the crank 300C (which is coupled to the body 113C) does not rotate. As above, lubricants, rollers, or other features can be disposed on the top facing proximate to aperture 301C to insure any external driver engaging the head 200 can rotate freely without frictionally engaging the crank 300C (which is effectively “locked out” by its attachment to the immovable top facing of body 113C).

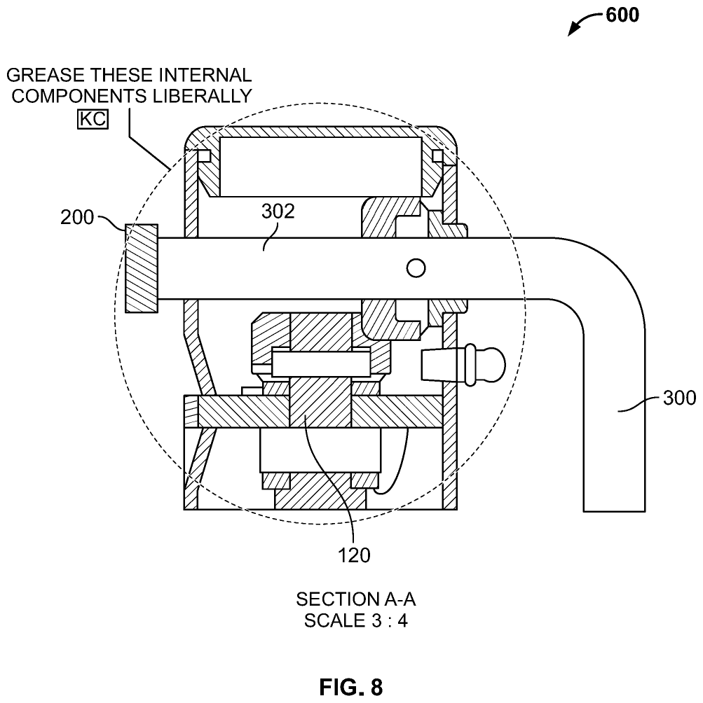

With reference to FIG. 8, a disengagement gear drive 600 can be employed with particular effect and utility on sidewinding jacks. Casing 10 is affixed over the end of the drive screw 120, with gears 6 interfacing with the crank 300 and/or drive head 610 to control rotation of the screw 120.

Here, a hex or other similar drive feature 610 (functionally identical to drive head 200) is affixed on the same or opposite side of the radial extension 302 of the crank 300. Pin 8 is received in and affixed to the crank 300. Orthogonally aligned, cooperating gear 6 are interposed on (directly or indirectly) the drive screw 120 at interface 5.

An axial displacement controller 7, such as a specialized washer, possibly having periodic, variable thickness (e.g., a wavy, planar shape) is coupled to crank 300 or integrally formed as radial flange thereon, with set corresponding positions or grooves possibly being formed on casing 10. Controller 7 facilitates the engagement or disengagement of pin 8 by moving the radial extension 302 and pin 8 into or out of the gears 6. Additionally or alternatively, hex driver 610 may be slid horizontally (as shown) to controllably engage or disengage the handle, again relying on pin 8 and/or the other mechanisms contemplated herein.

Driver 600 may serve as a replacement for drive head 200 or drive apparatus 202 contemplated in the other aspects above. In this manner, driver 600 may allow for easier access to the modified drive head 610. Accordingly, this configuration is best suited for side-winding installations. It can also be employed with any of the foregoing aspects so as to create additional iterations and options for converting a top-winding configuration into a side-winding configuration, and vice-versa.

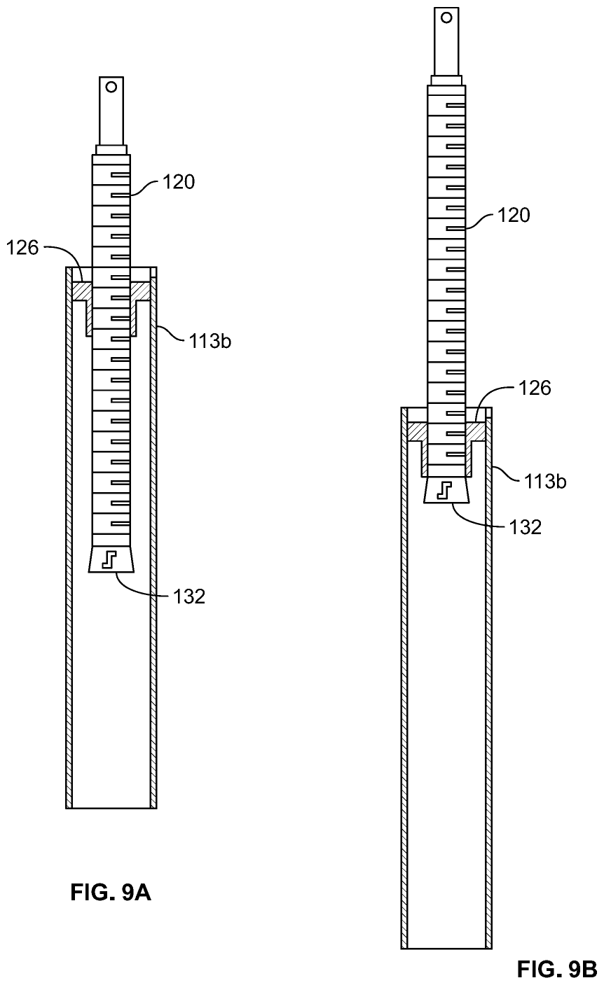

Finally, with reference to FIGS. 9A and 9B, the lower portion of the body of the jack is shown. These views are applicable to virtually any of the aforementioned aspects. It will also be understood that an engagement foot and/or further structure may be appended to the lower body 113b. Also, lower body 113b is coaxially received with the body 113 and slides up or down in response to rotation of the screw 120, as will be explained below.

Drive screw 120 includes an upper portion that is configured to couple to the drive head 200 (described above), while its lower portion includes a flange or widened portion 132. In both positions, mechanical jack screw limiting nut 126 is connected to housing section 113b, with mechanical jack screw 120 engaging the nut 126.

In FIG. 9A, screw 120 is at an intermediate screw jack position (i.e., between its minimum and maximum heights), so that portion 132 is not interferingly engaging the nut 126. However, FIG. 9B illustrates mechanical jack stroke limiting nut 126 interferingly engaging portion 132, with this position also corresponding to the overall mechanical screw jack maximum attainable length or height.

References to coupling or attachment in this disclosure are to be understood as encompassing any of the conventional means used in this field. In addition to specific structures depicted herein, conventional means may take the form of conventional or specially designed fasteners. Snap- or force fitting of components, possibly based upon bead-and-groove and/or slot-and-flange assemblies, could be employed depending upon the context and feasibility of accommodating such alternative arrangements. Adhesive could also be used. In all cases, the components and coupling means must be judiciously selected so as to be compatible while retaining the underlying design goals inherent to the assembly described herein.

The components should be made from materials selected to have sufficient structural integrity. The materials should also be selected for workability, longevity, cost, and weight. In addition to any materials specifically noted above, common grades of steel, metal, and metal alloys should have particular utility. Certain components could be tailored from engineered materials, possibly including common or specialty polymers and other similar materials.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

Having thus described the invention, the following is claimed:

1. A selectively engaged crank for a jack having manual drive and external drive actuation positions, the crank comprising:
a lift mechanism including a displacement screw contained within a housing;
a drive head extending out of the housing;
a crank member;
wherein the crank member: (i) is pivotally attached a collar positioned between the drive head and the housing to move the crank member through a range of motion less than 180° between a manual drive position and an external drive position, (ii) includes shank with a forked member that conforms to the drive head for rotary actuation of drive head in the manual drive position, and (iii) disengages the drive head in the external drive position to allow for tool-driven actuation of the drive head.

2. The crank according to claim 1, wherein the crank member includes a stopper adjacent to the forked member to facilitate engagement of: (i) the drive head in the manual drive position and/or (ii) lock out of the crank member in the external drive position.

3. The crank according to claim 1 wherein a connector on the housing couples the crank member to the housing so as to lock out the crank member when in the external drive position.

4. A selectively engaged crank for a jack having manual rotary actuation and tool-drive actuation positions, the crank comprising:
a lift mechanism including a displacement screw contained within a housing;
a drive head extending out of the housing;
a sliding sleeve positioned around an extension shaft coupled to the drive head, the sliding sleeve coupled to a crank member coupled and a slot formed within the sleeve;
a pin or protrusion extending radially out from the extension shaft; and
wherein the pin is positioned to rotate freely from the sliding sleeve when the drive head is engaged by a tool-drive actuator and wherein the slot is configured to receive and secure the pin within the slot when the sliding sleeve is axially displaced, thereby causing the crank member to drive the displacement screw.

5. The crank according to claim 4 wherein a biasing member is interposed between the sleeve and one of the drive head and the housing, the biasing member urging the pin into a preferred position.

6. The crank according to claim 4 wherein the slot is J-shaped.

7. A crank for a jack having manual rotary actuation and tool-drive actuation positions, the crank comprising:
a lift mechanism including a displacement screw contained within a housing;
a drive head extending out of the housing;
a crank member having a grip affixed to a distal end of a shank an engagement aperture formed at a proximal end, the engagement aperture shaped to cooperate with and engage the drive head when the crank member is in a manual operable position; and
a biasing member urging the crank member into one of the manual operable position or a tool-engaging position.

8. The crank according to claim 7 wherein the crank member includes a lengthwise slot formed on the crank member and wherein the grip is configured to be adjustably repositionable within the lengthwise slot.

9. The crank according to claim 8 wherein the lengthwise slot includes orthogonal notches to receive and secure the grip in high-speed and low-speed rotational engagement positions.

10. A selectively engaged crank for a jack having top-winding, manual rotary actuation and tool-drive actuation positions, the crank comprising:
a lift mechanism including a displacement screw contained within a housing;
a drive head extending out of the housing;
a crank member;
wherein the crank member is coupled to a collar having a notch or slot;
wherein the drive head includes a retractable torque pin received in the slot or notch to enable manual rotary actuation of drive head when the pin is extended and wherein axial force created during tool-drive actuation causes the torque pin to retract beneath the sleeve so that the crank member does not engage or spin during tool-drive actuation.

11. The crank according to claim 10 wherein the crank member can be selectively affixed to the housing during tool-drive actuation.

12. The crank according to claim 10 wherein the crank member includes a lengthwise slot formed on the crank member and wherein a grip is configured to be adjustably repositionable within the lengthwise slot.

13. The crank according to claim 12 wherein the lengthwise slot includes orthogonal notches to receive and secure the grip in high-speed and low-speed rotational engagement positions.

14. The crank according to claim 4 wherein the crank member includes a lengthwise slot formed on the crank member and wherein a grip is configured to be adjustably repositionable within the lengthwise slot.

15. The crank according to claim 14 wherein the lengthwise slot includes orthogonal notches to receive and secure the grip in high-speed and low-speed rotational engagement positions.

16. The crank according to claim 1 wherein the crank member includes a lengthwise slot formed on the crank member and wherein a grip is configured to be adjustably repositionable within the lengthwise slot.

17. The crank according to claim 16 wherein the lengthwise slot includes orthogonal notches to receive and secure the grip in high-speed and low-speed rotational engagement positions.

18. The crank according to claim 7 wherein the biasing member is a compression spring concealed within the housing and configured to urge the crank member into the manual operable position.

19. The crank according to claim 18 wherein the crank member includes a sleeve and wherein the sleeve is affixed to the housing so that, when axial force is applied to the crank member, the crank member, the sleeve, and the housing are displaced and the drive head is exposed in the tool-engaging position.
